(19) United States
(12) Patent Application Publication
(10) Pub. No.: US 2006/0267253 A1
(43) Pub. Date: Nov. 30, 2006

(54) Ultrasonic assisted processes

(75) Inventors: Jan Weber, Maple Grove, MN (US); Douglas A. Devens JR., St. Paul, MN (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Boston Scientific Scimed, Inc., Maple Grove, MN (US)

(21) Appl. No.: 11/501,094

(22) Filed: Aug. 8, 2006

Related U.S. Application Data
(62) Division of application No. 10/376,813, filed on Feb. 28, 2003.
(60) Provisional application No. 60/361,255, filed on Feb. 28, 2002.

(51) Int. Cl. B06B 1/02

(52) U.S. Cl. 264/444

(57) ABSTRACT

Method and apparatus for applying ultrasonic energy to a variety of manufacturing processes, particularly for producing an extrudate product from an extruder, wherein one or more ultrasonic transducers are utilized to uniformly ultrasonically vibrate at least a portion of an extruder assembly.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Parison tubes such as may be used in the manufacture of medical devices, such as catheters and balloons among others, are typically made by an extrusion process. An extrusion process may involve the melting of polymer pellets wherein the melted polymer is pushed through a tip and die combination to form a generally tubular shape. By pulling the tube at a higher speed than it is pushed out of the tip and die the diameter of the tube is reduced. This reduction is typically expressed as a draw down ratio. During the draw down process the polymer is oriented in the axial direction. From the resulting extrudate parison, balloons, for example may be subsequently formed. The higher the orientation in the extrudated parison, the higher the strength of the balloon.

Polymer melts have a relatively high viscosity and in order to reduce viscosity the temperature of the polymer melt is raised during the extrusion process. During extrusion at high temperatures however, some of the polymer will be degraded and burned particles may end up in the extruded product, thereby negatively influencing the product performance and yields. In addition, the orientation process may also be negatively affected by high temperatures. In some cases the hot polymer melt is not strong enough to remain intact during the draw down process.

In order to provide balloons with increased strength it would be desirable to maintain a reduced viscosity of the polymer melt without an undesirable increase in temperature during extrusion thereby improving the orientation process.

Other problems are known to be associated with prior extrusion processes. In some extrusion processes, such as intermittent layer coextrusion (ILC) or gradient extrusion, for example melt streams from two or more extruders are combined in an intermittent pattern in order to create tubes in which the polymer composition of the extrudated tube changes along the axial direction. During this process, the two or more melt streams must be guided through the same tip and die combination. During change over from one polymer to the next, the remaining volume of the last polymer stream is pushed out by the new polymer stream. If a high shear force exists between the polymer melt stream and the inner surface of the extruder head, then it will take considerable time to remove the complete skin layer of the polymer as the skin layer flows considerably slower than the main stream. The transition distance between two polymers in ILC or gradient extrusion is limited by the flow characteristics of the high viscous melt in the extruder head which forces the use of smaller extrusion heads at the cost of higher operating pressures to reduce the transition distance. This effect is particularly limiting where the extrudate is used to make thin walled catheters, balloon parisons, or similar tubular members in which the total volume per tubular member is low.

In many known extrusion processes polymers used in extrusion are often provided with ever-increasing molecular weight or contain an increasingly higher content of a filler such as inorganic material, to improve the desired physical properties, such as: strength, rigidity, slidability, or the like of the end product(s). However, such “improved” polymers typically exhibit poor fluidity in the die during extrusion, and as a result the surface of an article formed therefrom may be likely to form melt fractures. In addition the extremely high pressure needed to draw such a polymer through the die may result in deformation of the die, thereby resulting in a final product with a distorted shape.

Attempts have been made to remedy some of the problems described above. For example in U.S. Pat. No. 5,068,068 a method for carrying out an extrusion is provided wherein during polymer extrusion the extrusion die is resonated by an ultrasonic wave. The resonance provided to the die is said to reduce flow resistance of the extrusion material, inhibit melt fracture and improve productivity.

In other examples, ultrasonic energy is applied directly to the melt flow without applying it to the die, such as is described in U.S. Pat. No. 5,803,106 and U.S. Pat. No. 6,306,467.

The previous attempts to utilize ultrasonic energy in a polymer extrusion process may be undesirably limited and/or may be inappropriate for use in ILC or similar coextrusion processes. For example, in U.S. Pat. No. 5,068,068 the use of ultrasonic energy is limited to a standing wave pattern which has a frequency that is adjusted to keep the single standing wave pattern in place. A potential short coming of this method is that the standing wave will include node and loop portions that will likely create voids in the melt flow. A further shortcoming, is that the standing wave can only be maintained in a very simplistic crosshead with a very stable process, stable in the senses of temperature and meltflow. A further shortcoming, is that the standing wave will have a rather simplistic cross head that is easily disturbed. In the case of ILC and/or in extrusion processes using rotating tips and dies the complexity of the cross head is such that the creation of a uniform standing wave pattern may be impossible.

The present invention provides improved extrusion performance in ILC by applying ultrasonic energy directly to the extruder head. Unlike prior extrusion systems that use ultrasonic energy, in the present invention ultrasonic energy is provided in a multi-frequency format which provides vibration simultaneously at several frequencies which are harmonics of a fundamental frequency (e.g. frequency sweep). The resulting vibrations in the extruder head, breaks down adhesion of the polymer melt to the extruder wall thereby producing slip between the melt and wall. As a result, the flow rate of the melt may be improved, temperatures may be reduced, and performance of the ILC process may be enhanced. Additionally, the present invention provides improved processing and performance characteristics to a variety of processing applications.

The entire content of all of the patents listed within the present patent application are incorporated herein by reference.

### BRIEF SUMMARY OF THE INVENTION

In at least one aspect of the present invention ultrasonic energy is applied to the extruder head in order to induce slip thereby reducing friction between the polymer melt and the inner surface of the extruder. Reducing friction in this manner provides the polymer melt with a more uniform flow where the outside portions of the melt are moving through the extruder at substantially the same or a similar rate as the central portion of the melt. As a result undesired parabolic flow may be avoided and transition lengths of the extruded tube are substantially shortened.

In at least one embodiment of the invention, a continuous vibration may be applied to the filters and cross head used in a coextrusion process. The vibration reduces or substantially eliminates the resistance of these elements. By applying intermittent ultrasonic energy to the connection shaft, which links the individual extruders to the cross head resistance of the melt flow going to the cross head relative to the shaft can also be altered. The change in resistance of the connector shaft can be used as a switching function and one is able to switch the individual melt flows from the different extruders and thereby change the characteristics of the extrudate. While this affect may be somewhat similar to the affect of changing the melt pump speed in ILC (switching valves) or gradient extrusion, an advantage of this ultrasonic switching is an increase in speed of switching and the potential to modulate the melt stream by modulating the ultrasonic energy effecting the resistance.

In another aspect of the present invention, the entire extruder head is imparted with vibrations provided by one or more ultrasonic transducers. The unique use of one or more transducers as described herein avoids the risk of forming a standing wave at the cross head such as may be formed where a single frequency is applied to one specific location of the head. In the present invention it is desired to uniformly vibrate the entire assembly, wherein energy of the transducer or transducers is dispersed equally throughout the cross head. The assembly comprises the extrusion head, including a die and tip or tips, a filter housing, and a connection between the filter and the head.

In order to induce slip between the melt and the extruder surface, the ultrasonic vibration in the surface has to be larger then a certain threshold value, but below another value were the wall is heated too much due to the continuous transfer from mechanical energy to heat, wereas this increase in heat has a negative effect on the polymer melt. The preferred vibrational pattern of the assembly is such that the amplitude of the vibration is between these two values at all places in the assembly in contact with the melt flow.

In at least one embodiment of the invention, ultrasonic energy may be applied to the extruder or a portion thereof by one or more transducers that are attached to different locations on the extruder. The transducers are preferably configured to provide one or more frequencies of ultrasonic energy to the extruder. By utilizing a variety of transducers and frequencies vibration may be imparted to the entire extruder head, as well as other portions of the extruder if desired, thereby preventing a hold-up of polymer flow.

In at least one embodiment of the invention, the frequency of ultrasonic energy transmitted from one or more transducers to the extruder is modulated to provide a square wave output, frequency sweep, and/or a pulsed output.

In at least one embodiment of the invention, power supplied to an ultrasonic transducer is varied causing the output of the transducer to rapidly change. By measuring the effect this change has on the diameter of the extruded tube, for example by measuring the outer diameter using a laser sensor, and using an appropriate feedback mechanism towards the power supply of the transducers, one is able to generate a variety of patterns in the extrudated product.

In at least one embodiment, the invention may be utilized in bump extrusion. It is known that in order to change the outer diameter of an extruded tube, the line speed (i.e. pressure) of the extruder is altered. In the present embodiment, the amplitude of ultrasonic vibrations provided to the head by one or more transducers is altered which results in a controlled pressure change. This change in pressure causes significant dimensional changes in the extruded tube to occur. Within an air extrusion, the effect of a bump extrusion is limited by the compliance of the extrudated tube between the cross head and the puller. In other words, the change in force of the puller is not transferred completely to the melt leaving the tip and die, but is partly lost in extending or decreasing the section between the head and the tip\die. By modulating the ultrasonic energy vibrating the head, one is able to influence the melt stream in a much more direct sense. Of course the combination of both will further increase the capabilities of bump-extrusion in relation to quickly changing the dimension of the extrudated tube.

In at least one embodiment of the invention, extrusion characteristics may be altered by manipulating the ultrasonic energy transmitted to the extruder head. For example an extruded tube may be provided with portions having different thickness, strength, elasticity, and/or other characteristics.

In addition to enhancing extrusion processes and extruder performance, the use of ultrasonic energy may be applied to a variety of techniques and applications. For example: In electroplating and/or electropolishing processes local bubble formation is a known occurrence that when it occurs can block the process. In at least one embodiment of the invention, ultrasonic energy may be intermittently applied during the electroplating and/or electropolishing processes to resolve bubble formation thereby providing an improved, more uniform, electroplating and/or electropolishing action.

In at least one embodiment of the invention during the dip coating and/or spray coating process of some articles, particularly medical devices such as stents, ultrasonic energy may be utilized to induce slip at the surface boundaries between the coating solution and the stent surface. Inducement of slip is independent of the orientation of the surface. As a result, less drip formation will occur. This provides the additional benefit of allowing stents that define small cell openings, or narrow sections between adjacent struts, to be properly coated.

In at least one embodiment, the invention is directed to the application and use of ultrasonic energy during laser cutting applications. Particularly, the application of ultrasonic energy during the laser cutting of stents. The addition of ultrasonic energy during the laser cutting process has two effects. First of all, the flow of the liquid through the tube has an improved effect as the interaction between the wall and the fluid is improved. Secondly, it will decrease the attachment of dross to the tube by the fact that the molten material is less likely to attach to a vibrating surface.

In at least one embodiment of the invention, ultrasonic energy is applied during the process of coating tubular members, particularly catheter tubes. The application of ultrasonic energy to the coating process induces slip allowing the coating process of the tube to be much quicker than without the use of ultrasonic energy. The application of ultrasonic energy to the tube during the coating process is particularly useful for coating the inside surface of the tube where high viscosity fluid could otherwise be stuck in the lumen. By applying pressure to the fluid and applying using ultrasonic vibrations, the fluid is driven out of the lumen leaving a thin coating thereon.

In at least one embodiment, ultrasonic energy is used during laser bonding procedures, especially where bonding is to occur between polymer materials. Application of ultrasonic energy to the materials during laser heating will provide improved flow and mixing of the melted materials resulting in a stronger bond.

As will be recognized from the above summary the use of ultrasonic energy as described herein has many diverse and useful applications. Other applications encompassed by the present invention include:
The application and use of ultrasonic energy during stent crimping and loading processes where a stent is mounted and/or crimped to a catheter or balloon.
The loading of self-expandable stents into a sheath, whereby ultrasonic energy is applied to induce slip between the stent and sheath.
During dilitation procedures, ultrasonic energy is applied to the lumen of the balloon or to the fluid passing through the lumen to reduce inflation and deflation time.
During mixing procedures, particularly those involving composite polymers where in one or more polymers is mixed with nanoparticles, fibers, fillers or other materials, ultrasonic energy applied to the mixture in order to more uniformly distribute and combine the materials of the polymer matrix.

These and other more detailed and specific objectives are described in the following Detailed Description of the Invention in view of the Drawings.

### BRIEF DESCRIPTION OF THE SEVERAL VIEWS OF THE DRAWINGS

A detailed description of the invention is hereafter described with specific reference being made to the following drawings.

FIG. 1 is a diagrammatic view of an embodiment of the invention wherein a pair of extruders are linked together for coextrusion of a polymer melt through a cross head.

FIG. 2 is a side view of a melt flow seen flowing through a portion of an extruder as desired according to an aspect of the invention.

FIG. 3 is a PRIOR ART side view of a melt flow seen flowing through a portion of an extruder as may occur in a prior art extruder process.

FIG. 4 is a diagrammatic view of an embodiment of the invention wherein a pair of extruders are linked together for coextrusion of a polymer melt through a cross head.

FIG. 5 is a example of a modulated ultrasonic wave formed according to an embodiment of the invention.

FIG. 6 is a diagrammatic view of an embodiment of the invention wherein a pair of extruders are linked together for coextrusion of a polymer melt through a cross head.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

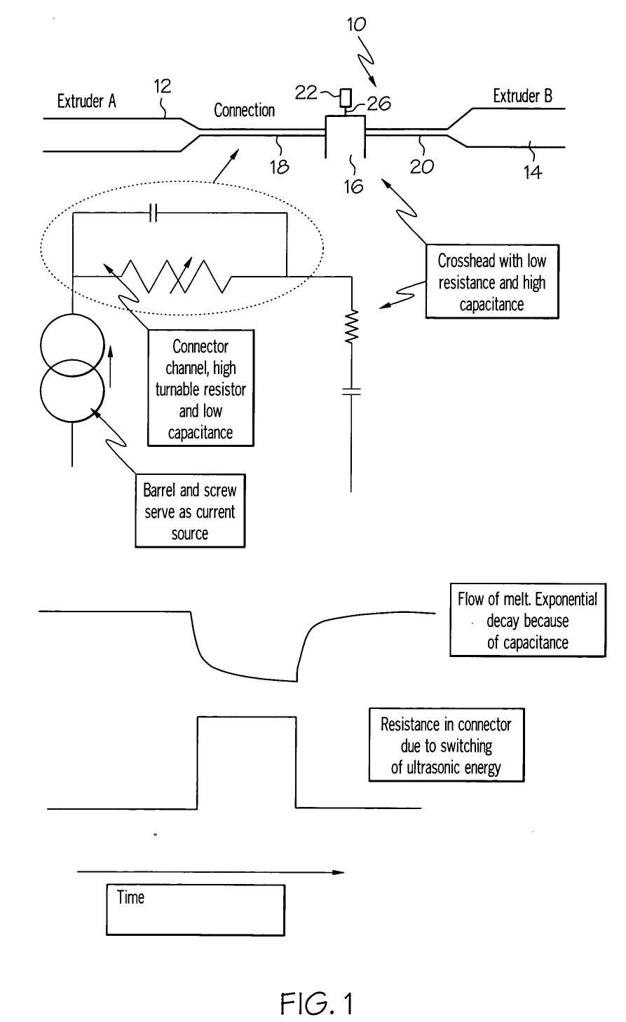

In at least one embodiment of the invention such as is shown in FIG. 1, an extrusion assembly, indicated generally at 10, includes a first extruder 12 and second extruder 14 in fluid communication with an extruder head or cross head 16. The extruders 12 and 14 are connected to the cross head 16 by a first connector 18 and a second connector 20 respectively. Multiple extruders may be used to provide an end product constructed from a variety of polymer materials and/or layers. Where multiple extruders are used in this manner the extruder assembly 10 may be utilized in ILC and/or gradient extrusion processes. In ILC the extruder apparatus preferably produces an end product that comprises a multi-layered tubular parison suitable for use in constructing medical devices such as balloons and/or catheters.

In some embodiments of the invention the extruder assembly 10 will include only one extruder and connector, or alternatively more than two extruders and connectors.

Extruder assembly 10 may be used to form a variety of extruded products. For example, parison tubes suitable for use in the manufacture of medical devices such as catheters and/or balloons, may be made by the extrusion process of the assembly 10. Within the extrusion process, polymer pellets are melted and pushed out through a tip and die combination in the head 16 into a predetermined shape, such as for example a tube. By pulling the tube at a higher speed than it is pushed out of the tip and die, the diameter of the tube can be reduced. This reduction in diameter is expressed as a draw down ratio. During the draw down process the polymer is oriented in the axial direction.

Where the assembly 10 is used in ILC or gradient extrusion, melt streams from extruders 12 and 14 are combined in an intermittent pattern in order to create tubes in which the polymer composition of the extrudated tube changes along the axial direction. The two melt streams have to be guided through the same tip and die combination of the head 16.

In at least one embodiment, the extruder apparatus includes one or more ultrasonic transducers 22 which are functionally engaged to one or more of the extruders 12 and 14, connectors 18 and 20, and head 16. Ultrasonic transducers 22 provide the assembly 10 with one or more ultrasonic waves, the ultrasonic energy provides the assembly or a portion thereof with a uniform vibration. While ultrasonic energy is known to have been applied to extruders and extruder processes such as described above, in the present invention ultrasonic energy is applied in a unique manner which provides a uniform vibration to a selected portion of the assembly while avoiding the undesirable effects of vibrational dead zones, hot spots or other inconsistencies as some prior ultrasonic energy applications are known to exhibit. In the present invention, the use of ultrasonic vibrations in the extruder head 16 or other portions of the assembly 10 will reduce the friction between the melt and the inner surface of an extruder 12 and 14, connector 18 and 20, and/or head 16. By inducing vibration in the assembly 10, particularly the extruder head 16, adhesion of the melt to the interior surfaces wall will break down and slip will be induced.

The inducement of slip by application of ultrasonic energy improves the extrusion process in a number of ways. For example, in some embodiments the inducement of slip will reduce the shear forces between the melt and the extruder head 16, and by that the total pressure in the extruder assembly 10 may also be reduced. This reduction in pressure allows for a reduction of the temperature of the melt. While the reduction of the temperature will likely increase the viscosity of the melt, this increase in viscosity is compensated for by the reduction of the friction forces between the melt and interior surfaces of the assembly 10.

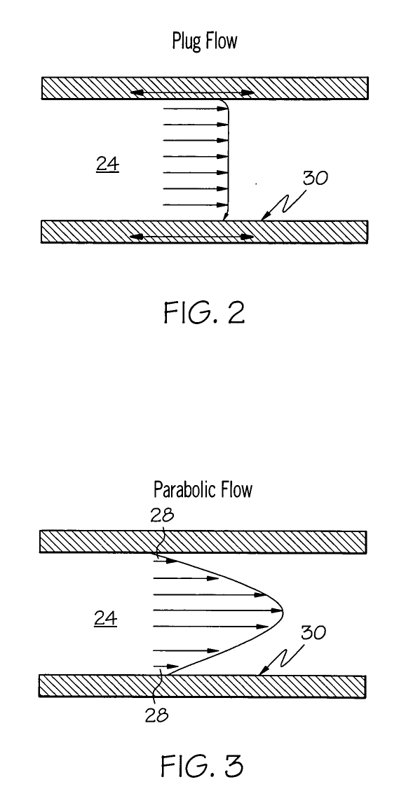

In addition to the above, by reducing the temperature, the chance for degradation of the polymer (and leaving burned particles in the product) is also reduced. This effect is further enhanced by the reduction of passage time of the skin layer of the polymer melt, leading to a more plug like melt flow 24 such as is shown in FIG. 2, rather than more parabolic melt flow shown in the prior art FIG. 3.

To better understand this effect, it should be considered that in prior designs the in the boundary layer 28 of the polymer melt 24, the polymer is flowing very slowly where it is in contact with the heated extruder surface 30 and submitted to high shear forces. In the present invention, such as is depicted in FIG. 2, the ultrasonic vibration will eliminate the boundary layer.

By reducing the temperature of the melt 24, the melt is much stronger during the draw down process. This will enable the draw down ratio to be increased. Furthermore, by operating the extruder process at lower temperatures the effect of the draw down orientation is enhanced. The removal of the boundary layer by inducing slip will be particularly useful in ILC extrusion and gradient extrusion by reducing the transition distance between two polymers in the head 16.

It is known that if the end product of an extruder is not cooled down to a sufficient extent after formation, the orientation of the polymer melt 24 during the draw down process will de-stabilize. An additional benefit of the present invention which utilizes ultrasonic vibrations is that by reducing the temperature of the melt in the extrusion process as described above, the potential for de-orientation of the polymer melt is also reduced. In addition, in the present invention reducing the temperature during extrusion as enabled through the use of uniform ultrasonic vibrations will reduce the potential and extent of melt fracture thereby allowing the potential to form polymer tubes having extremely thin walls.

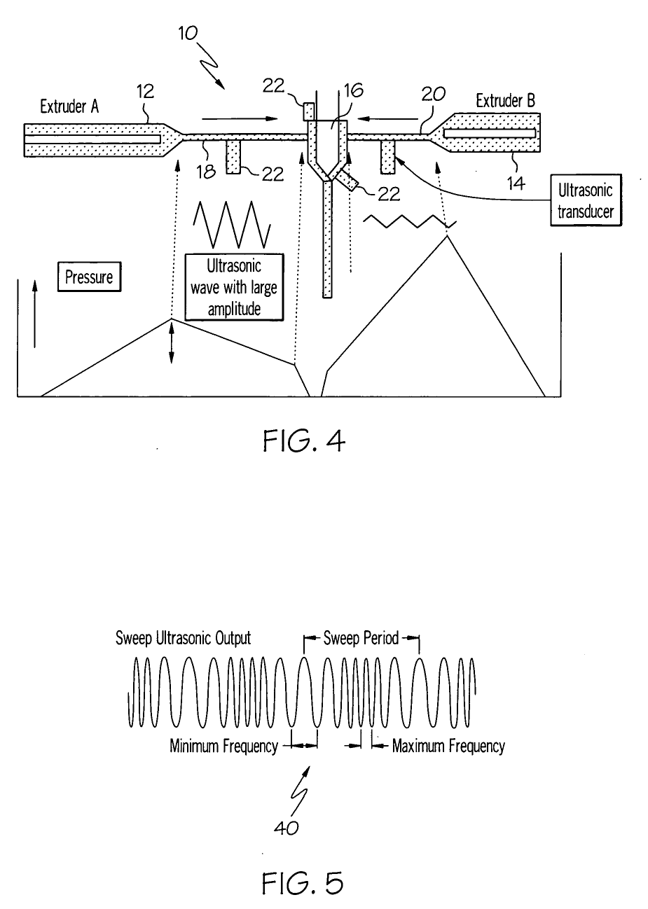

In order to achieve the results described above, in at least one embodiment, ultrasonic energy is applied directly to the extruder head 16. At least one transducer 22 is used to transmit ultrasonic energy to the head 16. In at least one alternative embodiment a plurality of transducers are applied to the head 16 and at least one of the connectors 18 and 20 such as is shown in FIG. 4.

The most straightforward process for providing ultrasonic energy to the head 16 is by attaching an ultrasonic transducer 22 firmly to the head 16. In some embodiments the transducer 22 is separated from the head 16 by a connection rod 26, such as is shown in FIG. 1, that shields the transducer from the high temperatures. The transducer 22 can be cooled at a remote location while continuously sending waves into the cross head structure. A suitable rod has to be made out of a stiff material, like Titanium or ceramic. There are however also high temperature, high power transducers 22 on the market which can be connected directly to the cross head 16. For example, the firm Etalon produces high power transducers available in frequencies from <20 KHz to 20 MHz, and suitable for use in operating temperatures >500° F. (260° C.).

Where the transducer 22 is connected to the head 16 (by rod 26 or directly), the ultrasonic waves produced by the transducer will travel and bounce inside the structure of the cross head 16 until they get transformed into heat. In at least one embodiment the, ultrasonic waves equally and uniformly vibrate the whole head 16, and the energy of the transducer is dispersed equally throughout the head 16. In order to vibrate the entire head 16 or any other portion of the assembly 10, a plurality of transducers 22 are attached at different locations operating at the same, but preferable different frequencies such as is shown in FIG. 4. The vibrational pattern created by each will be different and as a result the vibrational energy will be evenly distributed. By providing multiple frequencies from different transducers 22 the present invention avoids vibrational dead zones in the head 16, that is any place were there is no vibration. This complete and uniform vibrating of the head 16 will prevent hold-up of the polymer flow. In addition, any area in the extruder head 16 where the wave of one of the transducers is absent due to the standing wave effect, will be vibrating due to the wave(s) of one or more of the other transducers.

In some embodiments, a single transducer 22 may be used on the head 16, such as is shown in FIG. 1. Where a single transducer is used the frequency of the ultrasonic wave is modulated. Modem ultrasonic generators as used for example in the cleaning industry, are able to generate square wave output, frequency sweep as well as pulsed output. Such modulated frequencies will provide a similar uniform vibrational affect such as is described above.

Applying a square wave signal from an ultrasonic transducer 22 results in an acoustic output rich in harmonics. The result is a multi-frequency system which vibrates simultaneously at several frequencies which are harmonics of the fundamental frequency.

In a sweep operation, the frequency of the output of the ultrasonic generator is modulated around a central frequency 40 which may itself be adjustable such as is shown in FIG. 5. Various effects are produced by changing the speed and magnitude of the frequency modulation. The frequency may be modulated from once every several seconds to several hundred times per second with the magnitude of variation ranging from several hertz to several kilohertz. A frequency sweep of ultrasonic waves is useful in reducing the effects of standing waves.

Transducers are available in a variety of forms. Primarily, however, there are two types of ultrasonic transducers in use today: magnetostrictive and piezoelectric. Both types accomplish the same task of converting alternating electrical energy to vibratory mechanical energy but do it through the use of different means. Modern piezoelectric transducers are compacter, go to higher frequencies and are preferable.

Magnetostrictive transducers utilize the principle of magnetostriction in which certain materials expand and contract when placed in an alternating magnetic field. Piezoelectric transducers convert alternating electrical energy directly to mechanical energy through use of the piezoelectric effect in which certain materials change dimension when an electrical charge is applied to them.

High power generators for powering the transducers are widely available in the industry. Typically these generators can be tuned between 10% and full power, this generator is ample capable for the job. Altering the out put of the generator provides a simple means for altering the output of the transducer.

As these modem generators are fully programmable, it is an aspect of the present invention that the extrusion process could utilize a very efficient feedback loop in the extrusion process. In prior extrusion processes the line speed of the extruder out put uses a feedback loop in order to stabilize the dimensions of the extruded tube. In an aspect of the present invention the power of the transducer 22 may be increases or decreases causing the output to rapidly change.

In another embodiment, where the assembly 10 the amplitude of ultrasonic vibrations transmitted by the transducer 22 in the head 16 are altered. The resulting pressure drop in the head 16 allows for the existence of significant dimensional changes, particularly diameter, in the end product. A large ultrasonic amplitude will result in a pressure drop and vice versa. Typical extrusion pressures will be in the order of about 1000 psi to about 600 psi.

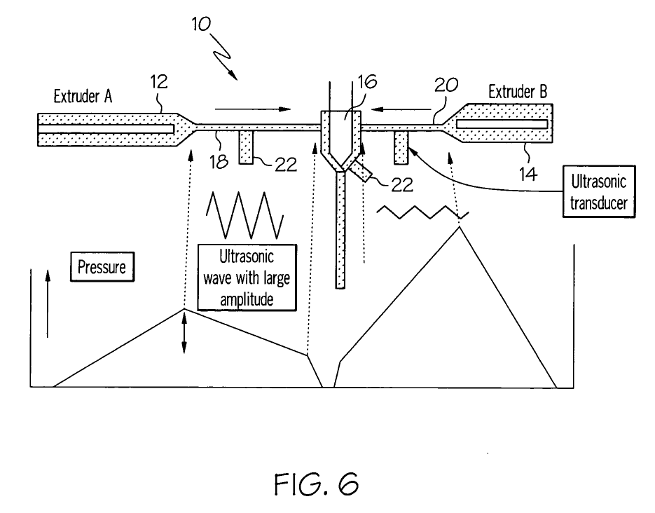

In some embodiments of the invention ultrasonic assisted extrusion is particularly applicable to coextrusion processes such as ILC. In coextrusion process, two (or more) extruders 12 and 14 are in fluid communication with a shared head 16 such as is depicted in FIG. 6. In the embodiment shown in FIG. 6, the connection members 18 and 20 have a very small inner diameter, the effect in analogue electrical terms will be an increase in resistance and a decrease in capacitance. The application of ultrasonic vibrations to this element will have the effect of reducing the resistance. The resistances of the other elements, such as the cross head 16 are likewise reduced.

Alternatively, if one applies continuous vibration to the filters and cross head, one can eliminate the resistance of these elements in the same manner as the connectors 18 and 20 such as are shown in FIG. 5. By applying intermittent ultrasonic energy to the connection shafts 18 and 20, the resistance of one or more of the connectors is reduced and as a result the resistance of melt flow therein going to the cross head is reduced and flow rate may be increase. As a result, this change in resistance of one or more of the connectors 18 and 20 functions as a switching mechanism wherein one is able to switch the individual melt flows from the different extruders and by that change the composition of the extrudate. The advantage of this ultrasonic switching rather than adjusting the melt pump speed, is the increased speed of switching and the possibility to modulate the melt stream by modulating the ultrasonic energy effecting the resistance.

In addition to being directed to the specific combinations of features claimed below, the invention is also directed to embodiments having other combinations of the dependent features claimed below and other combinations of the features described above.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

1-6. (canceled)

7. A method for providing intermittent layer coextrusion of polymer material comprising the steps of:
providing an extruder assembly, the extruder assembly comprising a first polymer extruder, a second polymer extruder and an extruder head, the first polymer extruder and the second polymer extruder in fluid communication with the extruder head and the extruder head having at least one ultrasonic transducer functionally engaged thereto;
providing a first polymer melt and a second polymer melt;
transmitting a plurality of ultrasonic waves with a plurality of frequencies to the entire extruder head from the at least one ultrasonic transducer; and
pushing the first polymer melt and the second polymer melt through the extruder head so that the first polymer melt is extruded as a substantially tubular shaped parison and the second polymer melt is deposited as a layer of material on at least a portion of the substantially tubular shaped parison.

8. The method of claim 7 wherein the plurality of ultrasonic waves are transmitted from the at least one ultrasonic transducer to the extruder head through at least one connection rod.

9. The method of claim 7, the extruder assembly further comprising a first connection member and a second connection member, the first connection member in fluid communication with the first polymer extruder and the extruder head, the second connection member in fluid communication with the second polymer extruder and the extruder head.

10. The method of claim 9, at least one of the first connection member and the second connection member having at least one ultrasonic transducer functionally engaged thereto and transmitting a plurality of ultrasonic waves with a plurality of frequencies to the at least one of the first connection member and the second connection member.

11. The method of claim 7, the substantially tubular shaped parison having a polymer composition wherein the polymer composition changes along an axial direction.

12. The method of claim 7, the extruder assembly further comprising at least one connection rod, the at least one connection rod engaged to the at least one ultrasonic transducer so that the at least one connection rod engages the at least one ultrasonic transducer to the extruder head.
